(19) United States
(12) Patent Application Publication
(10) Pub. No.: US 2026/0052349 A1
(43) Pub. Date: Feb. 19, 2026

(54) PIEZOELECTRIC SPEAKER

(71) Applicant: MERRY ELECTRONICS (SUZHOU) CO., LTD., Suzhou City (CN)

(72) Inventors: Chunlong ZHENG, Suzhou City (CN); Mingya LUO, Suzhou City (CN)

(73) Assignee: MERRY ELECTRONICS (SUZHOU) CO., LTD., Suzhou City (CN)

(21) Appl. No.: 19/169,125

(22) Filed: Apr. 3, 2025

(30) Foreign Application Priority Data
Aug. 19, 2024 (CN) 202411133459.9
Jan. 8, 2025 (CN) 202510028801.7

(51) Int. Cl. H04R 17/00; H04R 7/04; H04R 7/18

(52) U.S. Cl. CPC H04R 17/00; H04R 7/04; H04R 7/18; H04R 2400/11

(57) ABSTRACT

The present disclosure belongs to the technical field of sound-generating devices. Provided is a piezoelectric speaker. The piezoelectric speaker includes a support frame, a circuit assembly, a first diaphragm assembly, a second diaphragm assembly, and a vibration assembly. The periphery of the first diaphragm assembly is fixedly connected to the support frame. The periphery of the second diaphragm assembly is fixedly connected to the support frame. The vibration assembly is disposed in the cavity and located between the first diaphragm assembly and the second diaphragm assembly. The vibration assembly includes a first piezoelectric structure and a second piezoelectric structure that are disposed on the same layer on the support frame. The first piezoelectric structure is fixedly connected to the first diaphragm assembly and is configured to drive the first diaphragm assembly to vibrate in the first direction.

### CROSS-REFERENCE TO RELATED APPLICATION

This application claims priority to Chinese Patent Application No. 202411133459.9 filed Aug. 19, 2024 and No. 202510028801.7 filed Jan. 8, 2025, the disclosure of which is incorporated herein by reference in their entirety.

### TECHNICAL FIELD

The present disclosure relates to the technical field of sound-producing devices, in particular, a piezoelectric speaker.

### BACKGROUND

Speakers, as important electroacoustic devices, are widely used in electronic equipment. In terms of the technical type, speakers may be classified into dynamic speakers, balanced armature speakers, and piezoelectric speakers. Compared to dynamic speakers, piezoelectric speakers offer advantages such as being smaller, thinner, lighter, and free from magnetic interference.

In related art, a piezoelectric speaker includes a piezoelectric sheet and a diaphragm laminated with the piezoelectric sheet. Under the drive of a drive voltage, the piezoelectric sheet vibrates, causing the diaphragm to vibrate and thereby producing sound from the speaker. To enhance the sound performance of the speaker, two diaphragms are often employed, and the two diaphragms are arranged oppositely in the thickness direction of the piezoelectric speaker. To drive each diaphragm, two piezoelectric sheets are typically provided, and the two piezoelectric sheets are arranged between the two diaphragms at intervals and connected to the two diaphragms, respectively. However, since the piezoelectric speaker includes two piezoelectric sheets, piezoelectric speakers in the related art are relatively thick, presenting a need for improvement.

### SUMMARY

The first objective of the present disclosure is to provide a piezoelectric speaker with a smaller thickness and thinner weight.

As conceived above, the technical solution adopted by the present disclosure is as follows:

A piezoelectric speaker is provided and includes a support frame, a circuit assembly, a first diaphragm assembly, a second diaphragm assembly, and a vibration assembly.

The support frame forms a cavity penetrating an upper surface and a lower surface.

The circuit assembly is disposed in the support frame.

The periphery of the first diaphragm assembly is fixedly connected to the support frame.

The second diaphragm assembly is disposed opposite to the first diaphragm assembly in a first direction, and the periphery of the second diaphragm assembly is fixedly connected to the support frame.

The vibration assembly is disposed in the cavity and located between the first diaphragm assembly and the second diaphragm assembly. The vibration assembly includes a first piezoelectric structure and a second piezoelectric structure that are disposed on the same layer on the support frame. The first piezoelectric structure and the second piezoelectric structure are electrically connected to the circuit assembly. The first piezoelectric structure is fixedly connected to the first diaphragm assembly and is configured to drive the first diaphragm assembly to vibrate in the first direction. The second piezoelectric structure is fixedly connected to the second diaphragm assembly and is configured to drive the second diaphragm assembly to vibrate in the first direction.

In one or more embodiments, the vibration assembly also includes a first connector connected between the first piezoelectric structure and the first diaphragm assembly; and/or, the vibration assembly also includes a second connector connected between the second piezoelectric structure and the second diaphragm assembly.

In one or more embodiments, multiple first piezoelectric structures are provided, and the vibration assembly also includes a first connector connected to the first diaphragm assembly; one first connector is provided, and all first piezoelectric structures are connected to the one first connector to be connected to the first diaphragm assembly through the one first connector; or multiple first connectors are provided, and each first connector is connected to at least one first piezoelectric structure.

In one or more embodiments, multiple second piezoelectric structures are provided, and the vibration assembly also includes a second connector connected to the second diaphragm assembly; one second connector is provided, and all second piezoelectric structures are connected to the one second connector to be connected to the second diaphragm assembly through the one second connector; or multiple second connectors are provided, and each second connector is connected to at least one second piezoelectric structure.

In one or more embodiments, the first piezoelectric structure has a first free end and a first fixed end that are opposite to each other in a second direction, the first fixed end is connected to one end of the support frame, and the first free end is fixedly connected to the first diaphragm assembly; the second piezoelectric structure has a second free end and a second fixed end that are opposite to each other in the second direction, the second fixed end is connected to another end of the support frame, and the second free end is fixedly connected to the second diaphragm assembly; the first direction is perpendicular to the second direction.

In one or more embodiments, the orthographic projection of the first piezoelectric structure at least partially overlaps the orthographic projection of the second piezoelectric structure in a third direction; the third direction is perpendicular to the first direction and the second direction.

In one or more embodiments, multiple first piezoelectric structures are arranged in the third direction, at least one second piezoelectric structure is provided, two adjacent first piezoelectric structures in the third direction and one or more second piezoelectric structures form a piezoelectric group, and in one piezoelectric group, a second free end of the one or more second piezoelectric structures is located between two first piezoelectric structures in the third direction.

In one or more embodiments, the vibration assembly includes a first connector; in the one piezoelectric group, the two first piezoelectric structures are connected to the same first connector, the first connector is disposed across the one or more second piezoelectric structures, and a portion of the first connector opposite to the one or more second piezoelectric structures protrudes in a direction away from the one more second piezoelectric structures and is connected to the first diaphragm assembly.

In one or more embodiments, the first connector includes a crossbeam, two transition portions, and two connecting portions, the two transition portions are connected to two ends of the crossbeam, respectively, the two connecting portions are connected to the two transition portions in a one-to-one correspondence, the two connecting portions are connected to two first free ends, respectively, a transition portion forms an angle greater than 90 degrees with the crossbeam and forms an angle greater than 90 degrees with a connecting portion, and the crossbeam is connected to the first diaphragm assembly.

In one or more embodiments, multiple first piezoelectric structures and multiple second piezoelectric structures are provided, where multiple second piezoelectric structures are disposed between two first piezoelectric structures spaced apart in the third direction.

The vibration assembly also includes a second connector, the multiple second piezoelectric structures disposed between the two first piezoelectric structures are connected to the same second connector, and the second connector is connected to the second diaphragm assembly.

In one or more embodiments, the width of the first piezoelectric structure gradually decreases in a direction from the first fixed end to the first free end; and/or the width of the second piezoelectric structure gradually decreases in a direction from the second fixed end to the second free end.

In one or more embodiments, at the same time, the vibration direction of the first diaphragm assembly is opposite to the vibration direction of the second diaphragm assembly.

The beneficial effects of the present disclosure are described below.

In the piezoelectric speaker provided by the present disclosure, the first diaphragm assembly and the second diaphragm assembly are arranged opposite to each other in a first direction, and the vibration assembly includes a first piezoelectric structure and a second piezoelectric structure. The first piezoelectric structure for driving the first diaphragm assembly and the second piezoelectric structure for driving the second diaphragm assembly are arranged on the same layer. That is, the first piezoelectric structure and the second piezoelectric structure are on the same plane. This arrangement can reduce the space occupied by the vibration assembly in the first direction while ensuring effective driving performance, thereby minimizing the size of the piezoelectric speaker in the first direction and enabling the piezoelectric speaker to be thinner and lighter.

### BRIEF DESCRIPTION OF DRAWINGS

To illustrate the technical solutions in embodiments of the present disclosure more clearly, the drawings used in the description of the embodiments of the present disclosure are briefly described below. Apparently, the drawings described below illustrate only part of the embodiments of the present disclosure, and those of ordinary skill in the art may obtain other drawings based on the embodiments of the present disclosure and the drawings on the premise that no creative work is done.

FIG. 1 is a view illustrating the structure of a piezoelectric speaker according to an embodiment of the present disclosure.

FIG. 2 is a partial view of a piezoelectric speaker according to an embodiment of the present disclosure.

FIG. 3 is a first exploded view of a piezoelectric speaker according to an embodiment of the present disclosure.

FIG. 4 is an exploded view of a first piezoelectric structure according to an embodiment of the present disclosure.

FIG. 5 is a top view of a piezoelectric speaker without showing a first diaphragm assembly according to an embodiment of the present disclosure.

FIG. 6 is a second exploded view of the piezoelectric speaker according to an embodiment of the present disclosure.

FIG. 7 is a first sectional view of a piezoelectric speaker according to an embodiment of the present disclosure.

FIG. 8 is a second sectional view of the piezoelectric speaker according to an embodiment of the present disclosure.

FIG. 9 is a third exploded view of the piezoelectric speaker according to an embodiment of the present disclosure.

FIG. 10 is a top view of a portion of a piezoelectric speaker according to an embodiment of the present disclosure.

### DETAILED DESCRIPTION

To make problems to be solved, adopted solutions, and achieved effects of the present disclosure clearer, solutions of the present disclosure are further described below through embodiments in conjunction with drawings. It is to be understood that the embodiments described herein are intended to explain the present disclosure and not to limit the present disclosure. In addition, it should be noted that for ease of description, only the part, instead of all, related to the present disclosure is illustrated in the drawings.

It is to be noted that similar reference numerals and letters indicate similar items in subsequent drawings. Therefore, once a certain item is defined in one drawing, the item needs no more definition and explanation in the subsequent drawings.

In the description of the present disclosure, unless otherwise expressly specified and limited, the term “connected to each other”, “connected”, or “secured” is to be construed in a broad sense, for example, as securely connected, detachably connected, or integrated; mechanically connected or electrically connected; directly connected to each other or indirectly connected to each other via an intermediary; or internally connected between two components or interaction relations between two components. For those of ordinary skill in the art, specific meanings of the preceding terms in the present disclosure may be construed based on specific situations.

In the present disclosure, unless otherwise expressly specified and limited, when a first feature is described as “above” or “below” a second feature, the first feature and the second feature may be in direct contact or be in contact via another feature between the two features. Moreover, when the first feature is “on”, “above”, or “over” the second feature, the first feature is right on, above, or over the second feature, or the first feature is obliquely on, above, or over the second feature, or the first feature is simply at a higher level than the second feature. When the first feature is “under”, “below”, or “underneath” the second feature, the first feature is right under, below, or underneath the second feature, or the first feature is obliquely under, below, or underneath the second feature, or the first feature is simply at a lower level than the second feature. In the description of the embodiments, unless otherwise specified, “multiple” mentioned herein means two or more.

In the description of the embodiments, the orientation or position relationships indicated by terms such as “center”, “longitudinal”, “lateral”, “length”, “width”, “thickness”, “above”, “below”, “front”, “back”,” “left”, “right”, “vertical”, “horizontal”, “top”, “bottom”, “inside”, “outside”, “clockwise”, “counterclockwise”, “axial”, “radial”, and “circumferential” are based on the orientation or position relationships shown in the drawings, only for the convenience of description and simplification of operation, and do not indicate or imply that the apparatus or element referred to has a specific orientation and is constructed and operated in a specific orientation, and thus it is not to be construed as limiting the present disclosure. In addition, terms “first” and “second” are used only to distinguish between descriptions and have no special meaning.

It is to be noted that when a component is described as being “fixed to” or “set on” another component, it may be directly on the particular component or intervening components may be on the particular component.

The technical solutions of the present disclosure are described hereinafter in conjunction with drawings and embodiments.

This embodiment provides a piezoelectric speaker with a reduced thickness, suitable for use in electronic devices with high space requirements.

The speaker in this embodiment may be a MEMS (micro-electro-mechanical system) speaker. MEMS speakers can be widely used in current mobile electronic devices due to advantages such as low power consumption and light weight.

It should be noted that the electronic devices may include a mobile phone, a tablet personal computer, a laptop, a personal digital assistant (PDA), a camera, a personal computer, a vehicle-mounted device, a wearable device, augmented reality (AR) glasses, an AR helmet, virtual reality (VR) glasses, a VR helmet, a fixed-line handset (pickup), a medical auxiliary device (such as a hearing aid), various headphones (such as wireless headphones or wired headphones), and other devices with speakers. The specific forms of the above electronic devices are not specifically limited in the present application.

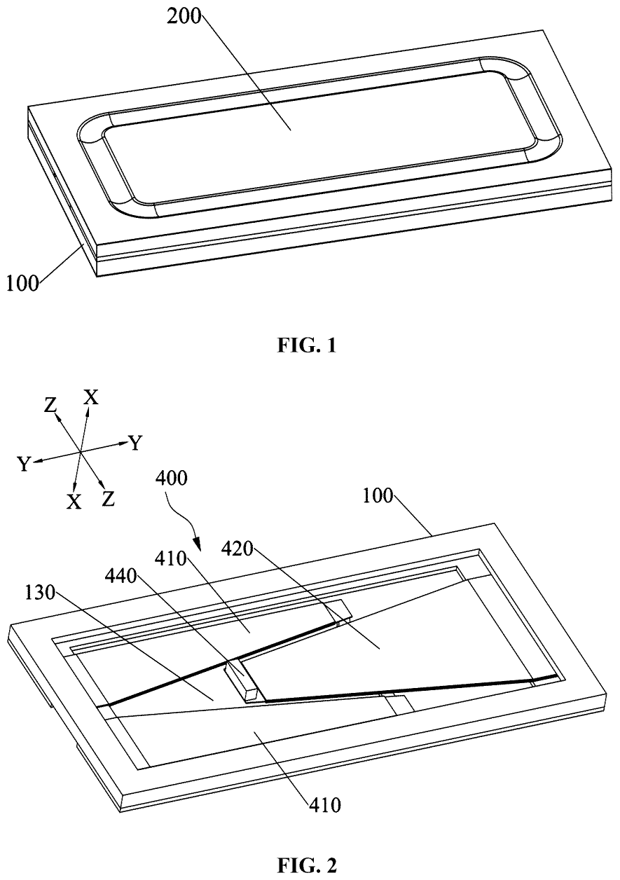

Before introducing this embodiment, for the convenience of the following description, a three-dimensional coordinate system may be established in certain figures. An example is used where the piezoelectric speaker shown in FIG. 1 is a rectangle. As shown in FIG. 2, the first direction X is the thickness direction of the piezoelectric speaker, the second direction Y is the length direction of the piezoelectric speaker, and the third direction Z is the width direction of the piezoelectric speaker. That is, any two of the first direction X, the second direction Y, and the third direction Z are perpendicular to each other. It can be understood that the width direction of the piezoelectric speaker is smaller than the length direction of the speaker.

In one or more embodiments, as shown in FIGS. 1 to 3, the piezoelectric speaker includes a support frame 100, a circuit assembly 500, a first diaphragm assembly 200, a second diaphragm assembly 300, and a vibration assembly 400.

In one or more embodiments, the support frame 100 is made of a hard material, such as metal and plastic, which is not limited in this embodiment. The support frame 100 is a frame structure. As shown in FIG. 7, the two surfaces of the support frame 100 in the first direction X are an upper surface 110 and a lower surface 120. As shown in FIG. 2, the support frame 100 forms a cavity 130 penetrating the upper surface 110 and the lower surface 120 to provide space for the vibration of the vibration assembly 400, the first diaphragm assembly 200, and the second diaphragm assembly 300.

In one or more embodiments, the support frame 100 may be an independent part or an assembly. For example, as shown in FIG. 2, the support frame 100 includes an upper frame 140 and a lower frame 150 connected to each other, and the upper frame 140 and the lower frame 150 are arranged in the first direction X.

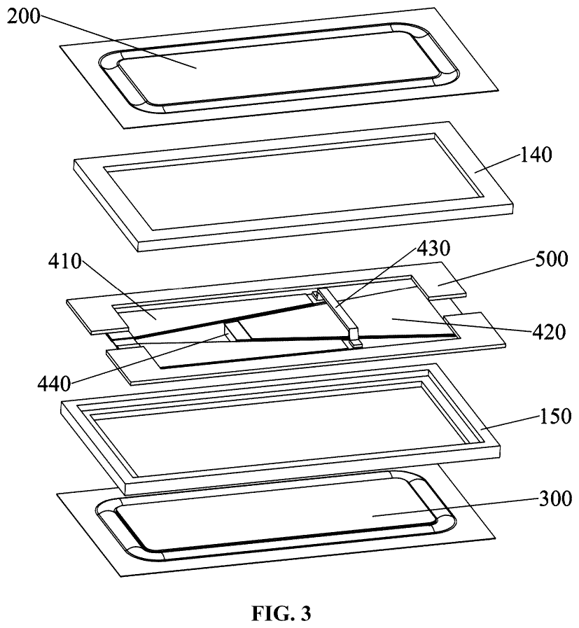

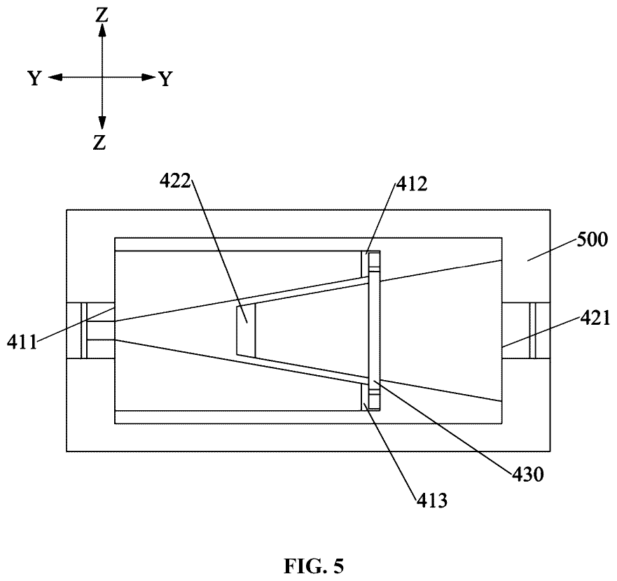

In one or more embodiments, as shown in FIG. 3 or FIG. 5, the circuit assembly 500 is disposed in the support frame 100 and is electrically connected to the vibration assembly 400, thereby providing acoustic and electrical signals to the vibration assembly 400. For example, the circuit assembly 500 may be clamped and fixed between the upper frame 140 and the lower frame 150. The circuit assembly 500 may include one or more circuit boards (not shown in the figures), which is not limited in this embodiment. A welding pad (not shown in the figures) is disposed on the circuit board, and the vibration assembly 400 may be welded on the welding pad to achieve the electrical connection between the circuit board and the vibration assembly 400.

In this embodiment, the first diaphragm assembly 200 is fixedly arranged on the support frame 100. Specifically, the periphery of the first diaphragm assembly 200 is fixedly connected to the support frame 100 and covers the cavity 130 of the support frame 100. The vibration assembly 400 can drive the first diaphragm assembly 200 to vibrate to achieve sound generation. For example, the periphery of the first diaphragm assembly 200 is fixedly connected to the upper frame 140; further, the periphery of the first diaphragm assembly 200 is fixedly connected to the surface of the upper frame 140 facing away from the lower frame 150.

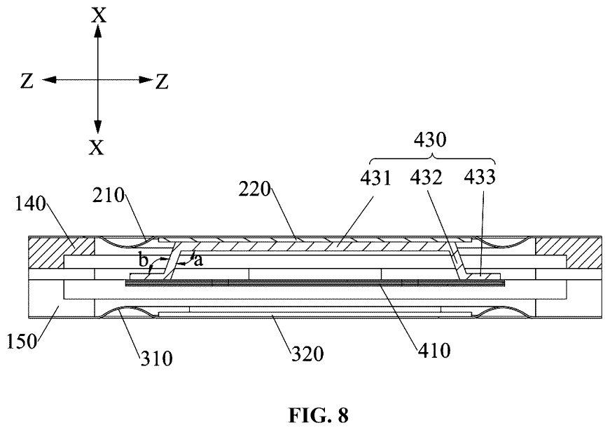

The specific structure of the first diaphragm assembly 200 may refer to the related art. In some optional embodiments, as shown in FIGS. 7 and 8, the first diaphragm assembly 200 includes a first diaphragm 210 and a first dome 220. The periphery of the first diaphragm 210 is fixedly connected to the support frame 100, the first dome 220 is connected to the surface of the first diaphragm 210 facing the cavity 130, and the vibration assembly 400 is connected to the first dome 220 to drive the first diaphragm 210 to vibrate through the first dome 220 to produce sound.

In this embodiment, the second diaphragm assembly 300 is fixedly arranged on the support frame 100 and is arranged opposite to the first diaphragm assembly 200 in the first direction X, forming a piezoelectric speaker with a double diaphragm assembly. Specifically, the periphery of the second diaphragm assembly 300 is fixedly connected to the support frame 100 and covers the cavity 130 of the support frame 100. The vibration assembly 400 can drive the second diaphragm assembly 300 to vibrate to produce sound. For example, the periphery of the second diaphragm assembly 300 is fixedly connected to the lower frame 150; further, the periphery of the second diaphragm assembly 300 is fixedly connected to the surface of the lower frame 150 facing away from the upper frame 140.

The specific structure of the second diaphragm assembly 300 may refer to the related art. In some optional embodiments, with continued reference to FIGS. 7 and 8, the second diaphragm assembly 300 includes a second diaphragm 310 and a second dome 320. The periphery of the second diaphragm 310 is fixedly connected to the support frame 100, the second dome 320 is connected to the surface of the second diaphragm 310 facing the cavity 130, and the vibration assembly 400 is connected to the second dome 320 to drive the second diaphragm 310 to vibrate through the second dome 320 to produce sound.

In one or more embodiments, as shown in FIG. 2, the vibration assembly 400 in this embodiment is arranged in the cavity 130 and is located between the first diaphragm assembly 200 and the second diaphragm assembly 300.

In some possible embodiments, as shown in FIG. 2, the vibration assembly 400 includes a first piezoelectric structure 410 and a second piezoelectric structure 420 that are disposed on the same layer on the support frame 100. The first piezoelectric structure 410 and the second piezoelectric structure 420 are both electrically connected to the circuit assembly 500 so that the circuit assembly 500 can provide acoustic and electrical signals to the first piezoelectric structure 410 and the second piezoelectric structure 420.

In this embodiment, the first piezoelectric structure 410 is connected to the first diaphragm assembly 200 and is configured to drive the first diaphragm assembly 200 to vibrate in the first direction X, and the second piezoelectric structure 420 is connected to the second diaphragm assembly 300 and is configured to drive the second diaphragm assembly 300 to vibrate in the first direction X. In this manner, the two piezoelectric structures used to drive the two diaphragm assemblies are located in the same layer, thereby reducing the thickness of the vibration assembly 400. Furthermore, the thickness of the piezoelectric speaker is reduced so that the space occupied by the piezoelectric speaker in the thickness direction is minimized, the piezoelectric speaker can be thinner and lighter, and the electronic device using the piezoelectric speaker is thinner and lighter. It should be noted that a gap is present between the first piezoelectric structure 410 and the second piezoelectric structure 420, that is, the first piezoelectric structure 410 and the second piezoelectric structure 420 do not contact each other. In this manner, the two do not interfere with each other, ensuring the normal use of the piezoelectric speaker and preventing the generation of noise.

In the piezoelectric speaker provided in this embodiment, the first diaphragm assembly 200 and the second diaphragm assembly 300 are arranged opposite to each other in a first direction X, and the vibration assembly 400 includes a first piezoelectric structure 410 and a second piezoelectric structure 420. The first piezoelectric structure 410 for driving the first diaphragm assembly 200 and the second piezoelectric structure 420 for driving the second diaphragm assembly 300 are arranged on the same layer. That is, the first piezoelectric structure 410 and the second piezoelectric structure 420 are on the same plane. This arrangement can reduce the space occupied by the vibration assembly 400 in the first direction X while ensuring effective driving performance, thereby minimizing the size of the piezoelectric speaker in the first direction X and enabling the piezoelectric speaker to be thinner and lighter.

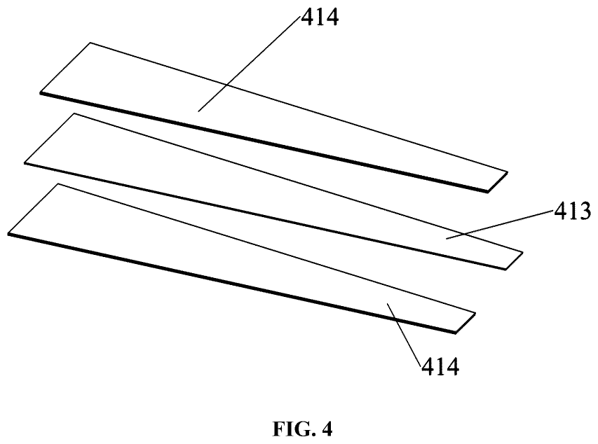

In some optional embodiments, as shown in FIG. 4, the first piezoelectric structure 410 includes a first substrate 413 and a first piezoelectric sheet 414 disposed on at least one side of the first substrate 413 in the first direction X. In this embodiment, two sides of the first substrate 413 in the first direction X are provided with first piezoelectric sheets 414. The material of the first substrate 413 may be plastic or metal. The material of the first piezoelectric sheet 414 may be piezoelectric ceramic. After being energized, the first piezoelectric sheet 414 deforms upward or downward in the first direction X based on the energized polarity, thereby driving the first substrate 413 to move in the first direction X. In addition, the first piezoelectric structure 410 has a first free end 412 and a first fixed end 411 that are opposite to each other in a second direction Y, and the first fixed end 411 is connected to one end of the support frame 100 and is electrically connected to the circuit assembly 500. Specifically, the first substrate 413 of the first fixed end 411 is connected to one end of the support frame 100, and the first piezoelectric sheet 414 of the first fixed end 411 is electrically connected to the circuit assembly 500 so that the circuit assembly 500 inputs acoustic and electrical signals to the first piezoelectric sheet 414. The first free end 412 is arranged on the side of the first diaphragm assembly 200 facing the second diaphragm assembly 300 and is fixedly connected to the first diaphragm assembly 200. Specifically, the first substrate 413 of the first free end 412 is fixedly connected to the first diaphragm assembly 200 and is configured to drive the first diaphragm assembly 200 to vibrate in the first direction X.

In this embodiment, one end of the first piezoelectric structure 410 is fixedly connected to the support frame 100, and another end is suspended in the cavity 130 to form a cantilever beam structure. After the first piezoelectric sheet 414 is energized, the first piezoelectric structure 410 of the cantilever beam structure deforms in the first direction X so that the first substrate 413 of the first free end 412 vibrates, thereby driving the first diaphragm assembly 200 to vibrate and causing the first diaphragm assembly 200 to push the air to produce sound.

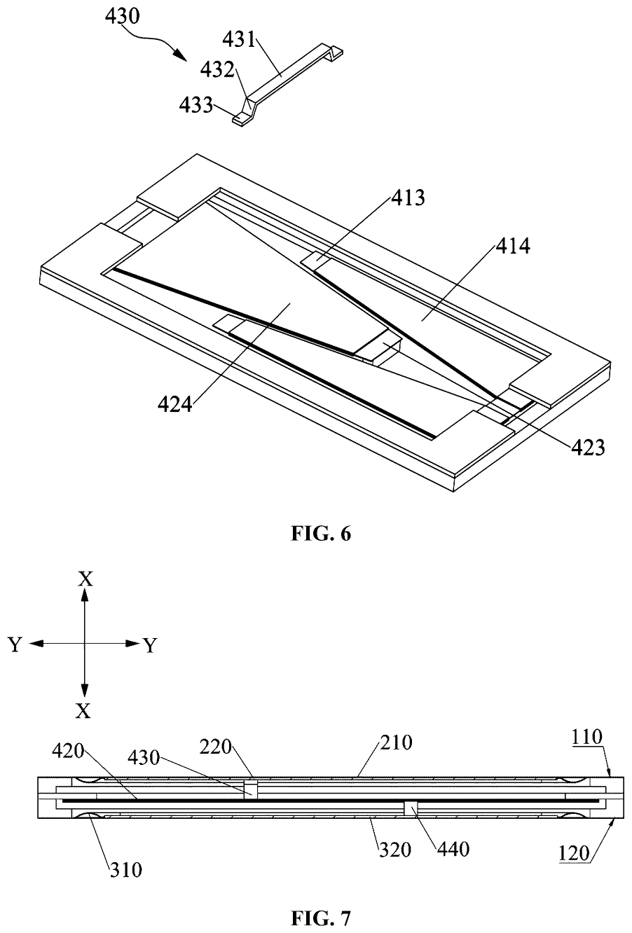

The specific structure of the second piezoelectric structure 420 is similar to that of the first piezoelectric structure 410. Specifically, as shown in FIG. 6, the second piezoelectric structure 420 includes a second substrate 423 and a second piezoelectric sheet 424 disposed on at least one side of the second substrate 423 in the first direction X. In this embodiment, two sides of the second substrate 423 in the first direction X are connected to second piezoelectric sheets 424. The material of the second substrate 423 may be plastic or metal. The material of the second piezoelectric sheet 424 may be piezoelectric ceramic. After being energized, the second piezoelectric sheet 424 deforms upward or downward in the first direction X based on the energized polarity, thereby driving the second substrate 423 to move in the first direction X. In addition, the second piezoelectric structure 420 has a second free end 422 and a second fixed end 421 that are opposite to each other in the second direction Y, and the second substrate 423 of the second fixed end 421 is connected to another end of the support frame 100 and is electrically connected to the circuit assembly 500. Specifically, the second substrate 423 of the second fixed end 421 is connected to another end of the support frame 100, and the second piezoelectric sheet 424 of the second fixed end 421 is electrically connected to the circuit assembly 500 so that the circuit assembly 500 inputs acoustic and electrical signals to the second piezoelectric sheet 424. The second free end 422 is arranged on the side of the second diaphragm assembly 300 facing the first diaphragm assembly 200 and is fixedly connected to the second diaphragm assembly 300. Specifically, the second substrate 423 of the second free end 422 is fixedly connected to the second diaphragm assembly 300 and is configured to drive the second diaphragm assembly 300 to vibrate in the first direction X.

In this embodiment, one end of the second piezoelectric structure 420 is fixedly connected to the support frame 100, and another end is suspended in the cavity 130 to form a cantilever beam structure. After the second piezoelectric sheet 424 is energized, the second piezoelectric structure 420 of the cantilever beam structure deforms in the first direction X so that the second substrate 423 of the second free end 422 vibrates, thereby driving the second diaphragm assembly 300 to vibrate and causing the second diaphragm assembly 300 to push the air to produce sound.

In some optional embodiments, at the same time, the vibration direction of the first diaphragm assembly 200 is opposite to the vibration direction of the second diaphragm assembly 300. That is, at the same time, the first vibration assembly 200 and the second diaphragm assembly 300 move toward or away from each other so that the motion directions of the two are opposite, thereby playing a role in shock absorption and reducing the overall vibration amplitude of the piezoelectric speaker. Moreover, the impact of the piezoelectric speaker on other components in the electronic device is reduced, and this arrangement ensures the reliability of the electrical connection between the first piezoelectric sheet 414 of the first piezoelectric structure 410, the second piezoelectric sheet 424 of the second piezoelectric structure 420, and the circuit assembly 500.

It can be understood that the vibration direction of the first diaphragm assembly 200 is the same as the vibration direction of the first piezoelectric structure 410, and the vibration direction of the second diaphragm assembly 300 is the same as the vibration direction of the second piezoelectric structure 420. For example, the circuit assembly 500 may input acoustic and electrical signals of equal magnitude and opposite polarity to the first piezoelectric sheet 414 and the second piezoelectric sheet 424 so that the deformation amplitudes of the first piezoelectric sheet 414 and the second piezoelectric sheet 424 are the same, but the deformation directions are opposite. In this manner, the vibration directions of the first piezoelectric structure 410 and the second piezoelectric structure 420 are opposite.

The first piezoelectric structure 410 usually maintains a state of extending in the second direction Y when not vibrating, and the first piezoelectric structure 410 and the first diaphragm assembly 200 have a certain distance in the first direction X. Therefore, if the first substrate 413 of the first piezoelectric structure 410 is directly connected to the first diaphragm assembly 200, the first substrate 413 is bent toward the first diaphragm assembly 200, and the first diaphragm assembly 200 is pulled. In this manner, it is easy to cause damage to the first diaphragm assembly 200.

For this reason, as shown in FIG. 3, the vibration assembly 400 in this embodiment also includes a first connector 430. The first connector 430 is connected between the first piezoelectric structure 410 and the first diaphragm assembly 200. For example, the first connector 430 is connected between the first substrate 413 of the first free end 412 and the first diaphragm assembly 200. The first connector 430 is configured so that when the first piezoelectric structure 410 is not vibrating, it is ensured that the first piezoelectric structure 410 remains extended in the second direction Y and does not pull the first diaphragm assembly 200, thereby reducing the probability of damage to the first diaphragm assembly 200. Moreover, by setting the first connector 430, it is also ensured that the distance between the first piezoelectric structure 410 and the first diaphragm assembly 200 is a certain value, which is convenient for controlling the vibration of the first diaphragm assembly 200. In addition, when the connection area of the first free end 412 is small, setting the first connector 430 can increase the connection area between the first connector 430 and the first diaphragm assembly 200, thereby improving the connection stability and reliability.

Similarly, to reduce the probability of damage to the first diaphragm assembly 200, as shown in FIG. 3, the vibration assembly 400 also includes a second connector 440 connected between the second piezoelectric structure 420 and the second diaphragm assembly 300. For example, the second connector 440 is connected between the second free end 422 and the second diaphragm assembly 300. The second connector 440 is configured so that when the second piezoelectric structure 420 is not vibrating, it is ensured that the second piezoelectric structure 420 remains extended in the second direction Y and does not pull the second diaphragm assembly 300, thereby reducing the probability of damage to the second diaphragm assembly 300. Moreover, by setting the second connector 440, it is also ensured that the distance between the second piezoelectric structure 420 and the second diaphragm assembly 300 is a certain value, which is convenient for controlling the vibration of the second diaphragm assembly 300. In addition, when the connection area of the second free end 422 is small, setting the second connector 440 can increase the connection area between the second connector 440 and the second diaphragm assembly 300, thereby improving the connection stability and reliability.

The number of the first piezoelectric structures 410 may be selected as required. One or more first piezoelectric structures 410 may be provided. When one first piezoelectric structure 410 is provided, one first connector 430 is provided. When multiple first piezoelectric structures 410 are provided, the number of first connectors 430 may vary.

In some optional embodiments, when multiple first piezoelectric structures 410 are provided, one first connector 430 is provided, and all first piezoelectric structures 410 are connected to the one first connector 430 to be connected to the first diaphragm assembly 200 through the first connector 430. In this manner, the number of first connectors 430 can be reduced, and the consistency of the movement of the first diaphragm assembly 200 can be ensured. Thus, the number of components of the piezoelectric speaker is small, making assembly easier.

In some other optional embodiments, when multiple first piezoelectric structures 410 are provided, multiple first connectors 430 are provided, and each first connector 430 is connected to at least one first piezoelectric structure 410. For example, multiple first connectors 430 and multiple first piezoelectric structures 410 are in a one-to-one correspondence, and each first piezoelectric structure 410 is connected to a corresponding first connector 430 so that each first piezoelectric structure 410 can be connected to the first diaphragm assembly 200 through a first connector 430. Alternatively, multiple first connectors 430 are provided, each of which connects at least two first piezoelectric structures 410. That is, at least two first piezoelectric structures 410 share one first connector 430, which can reduce the number of first connectors 430 used.

Similarly, the number of the second piezoelectric structures 420 may be selected as required. One or more second piezoelectric structures 420 may be provided. When one second first piezoelectric structure 420 is provided, one second connector 440 is provided. When multiple second piezoelectric structures 420 are provided, the number of second connectors 440 may vary.

In some optional embodiments, when multiple second piezoelectric structures 420 are provided, one second connector 440 is provided, and all second piezoelectric structures 420 are connected to the one second connector 440 to be connected to the second diaphragm assembly 300 through the second connector 440. In this manner, the number of second connectors 440 can be reduced, and the consistency of the movement of the second diaphragm assembly 300 can be ensured. Thus, the number of components of the piezoelectric speaker is small, making assembly easier.

In some other optional embodiments, when multiple second piezoelectric structures 420 are provided, multiple second connectors 440 are provided, and each second connector 440 is connected to at least one second piezoelectric structure 420. For example, multiple second connectors 440 and multiple second piezoelectric structures 420 are in a one-to-one correspondence, and each second piezoelectric structure 420 is connected to a corresponding second connector 440 so that each second piezoelectric structure 420 can be connected to the second diaphragm assembly 300 through a second connector 440. Alternatively, when multiple second piezoelectric structures 420 are provided, multiple second connectors 440 are provided, and each second connector 440 is connected to at least two second piezoelectric structures 420, that is, at least two second piezoelectric structures 420 share one second connector 440, which can reduce the number of second connectors 440 used.

To improve the low-frequency sensitivity of the speaker, in one or more embodiments, as shown in FIG. 5, the orthographic projection of the first piezoelectric structure 410 at least partially overlaps the orthographic projection of the second piezoelectric structure 420 in a third direction Z, that is, the orthographic projections of the first piezoelectric structure 410 and the second piezoelectric structure 420 in the third direction Z have overlapping parts. In other words, the first piezoelectric structure 410 and the second piezoelectric structure 420 can be staggered with each other so that the lengths of the first piezoelectric structure 410 and the second piezoelectric structure 420 can be longer to increase the areas of the first piezoelectric structure 410 and the second piezoelectric structure 420 and further improve the sensitivity of the piezoelectric speaker. Moreover, the first piezoelectric structure 410 and the second piezoelectric structure 420 have a longer length so that the force applied by the first piezoelectric structure 410 on the first diaphragm assembly 200 can be closer to being perpendicular to the first diaphragm assembly 200, and the force applied by the second piezoelectric structure 420 on the second diaphragm assembly 300 can be closer to being perpendicular to the second diaphragm assembly 300, thereby improving the driving effect on the first diaphragm assembly 200 and the second diaphragm assembly 300. In addition, the longer lengths of the first piezoelectric structure 410 and the second piezoelectric structure 420 also reduce the resonance frequency, thereby increasing the low-frequency sensitivity of the piezoelectric speaker.

In one or more embodiments, the area of the part where the orthographic projection of the first piezoelectric structure 410 overlaps the orthographic projection of the second piezoelectric structure 420 in the third direction Z is smaller than the area of the orthographic projection of the first piezoelectric structure 410 in the third direction Z and is smaller than the area of the orthographic projection of the second piezoelectric structure 420 in the third direction Z.

In some optional embodiments, when multiple first piezoelectric structures 410 and multiple second piezoelectric structures 420 are provided, the first free ends 412 of the multiple first piezoelectric structures 410 and the second free ends 422 of the multiple second piezoelectric structures 420 are alternately arranged in the third direction Z so that the first piezoelectric structure 410 does not affect the extension of the second piezoelectric structure 420 in the second direction Y, and the second piezoelectric structure 420 does not affect the extension of the first piezoelectric structure 410 in the second direction Y. Thus, the lengths of the first piezoelectric structure 410 and the second piezoelectric structure 420 in the first direction X can be longer, thereby reducing the resonance frequency and improving the low-frequency sensitivity. Moreover, the first piezoelectric structure 410 and the second piezoelectric structure 420 are alternately arranged, which improves the uniformity of the distribution of the connection positions between the first piezoelectric structure 410 and the first diaphragm assembly 200 in the third direction Z, as well as the uniformity of the distribution of the connection positions between the second piezoelectric structure 420 and the second diaphragm assembly 300 in the third direction Z. Moreover, this arrangement reduces the likelihood of damage to the first diaphragm assembly 200 and the second diaphragm assembly 300 due to localized excessive force, thereby enhancing the stability of the driving effect on both the first diaphragm assembly 200 and the second diaphragm assembly 300.

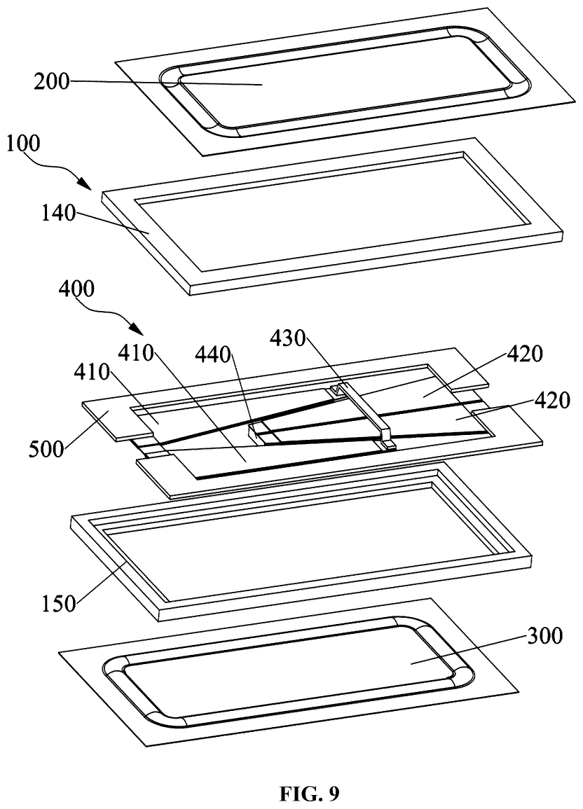

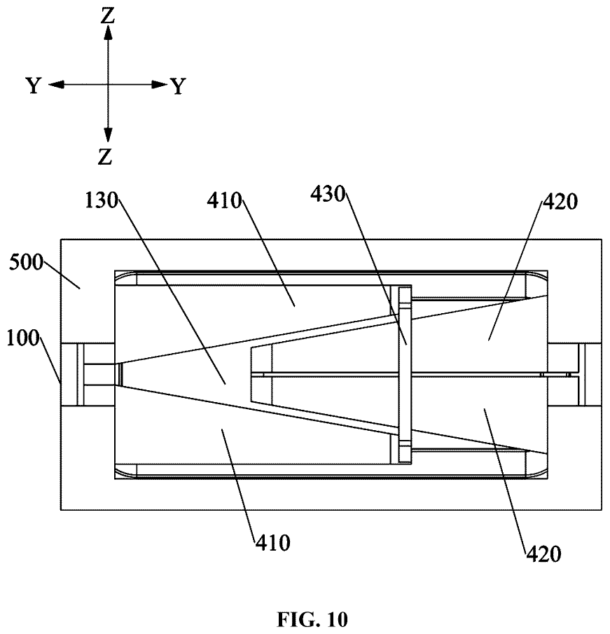

In some other optional embodiments, when multiple first piezoelectric structures 410 and multiple second piezoelectric structures 420 are provided, the multiple first piezoelectric structures 410 and multiple second piezoelectric structures 420 may not be arranged alternately. For example, as shown in FIGS. 9 and 10, multiple second piezoelectric structures 420 are disposed between two first piezoelectric structures 410 spaced apart in the third direction Z. It can be understood that multiple first piezoelectric structures 410 may be disposed between two second piezoelectric structures 420 spaced apart in the third direction Z, which is not limited in this embodiment.

Further, when multiple second piezoelectric structures 420 are disposed between two first piezoelectric structures 410 spaced apart in the third direction Z, the multiple second piezoelectric structures 420 located between the two first piezoelectric structures 410 are connected to the same second connector 440.

In this embodiment, as shown in FIGS. 5 and 6, multiple first piezoelectric structures 410 are arranged in the third direction Z, and at least one second piezoelectric structure 420 is provided. Two adjacent first piezoelectric structures 410 and one or more second piezoelectric structures 420 in the third direction Z form a piezoelectric group (not shown in the figures). The vibration assembly 400 includes at least one piezoelectric group. When the vibration assembly 400 includes multiple piezoelectric groups, the multiple piezoelectric groups are arranged in sequence in the third direction Z. In one piezoelectric group, the second free end 422 of one or more second piezoelectric structures 420 is located between two first piezoelectric structures 410 in the third direction Z to fully utilize the space of the piezoelectric speaker in the third direction Z. It should be noted that when multiple piezoelectric groups are provided, two adjacent piezoelectric groups in the third direction Z may be independent of each other, that is, the first piezoelectric structure 410 in one piezoelectric group is not reused in another piezoelectric group. Alternatively, the two adjacent piezoelectric groups in the third direction Z may also share a first piezoelectric structure 410, that is, the first piezoelectric structure 410 in one piezoelectric group may also be used as the first piezoelectric structure 410 in another piezoelectric group, which is not limited in this embodiment.

In this embodiment, as shown in FIG. 5 and FIG. 6, two first piezoelectric structures 410 and one second piezoelectric structure 420 are provided. The second free end 422 of the second piezoelectric structure 420 is located between two first piezoelectric structures 410 in the third direction Z. In this manner, the number of first piezoelectric structures 410 and the number of second piezoelectric structures 420 are not too large, and the number of components of the piezoelectric speaker can be reduced on the basis of achieving the drive of the two diaphragm assemblies.

Further, with continued reference to FIGS. 5 and 6, in one piezoelectric group, two first piezoelectric structures 410 are connected to the same first connector 430, the first connector 430 is disposed across one or more second piezoelectric structures 420 in the piezoelectric group, and the portion of the first connector 430 opposite to the one or more second piezoelectric structures 420 protrudes in a direction away from the one more second piezoelectric structures 420 and is connected to the first diaphragm assembly 200 to achieve the connection between the two first piezoelectric structures 410 and the first diaphragm assembly 200. The portion of the first connector 430 opposite to the one or more second piezoelectric structures 420 protrudes in a direction away from the one more second piezoelectric structures 420. Thus, on the one hand, this arrangement facilitates the connection with the first diaphragm assembly 200. On the other hand, this arrangement also reserves a vibration space for one or more second piezoelectric structures 420, ensuring that the first connector 430 does not interfere with the vibration of the second piezoelectric structures 420. When the second piezoelectric structure 420 vibrates, the second piezoelectric structure 420 does not collide with the first connector 430, preventing noise generation in the piezoelectric speaker and ensuring the accuracy of the driving of the second diaphragm assembly 300 by the second piezoelectric structure 420.

In one or more embodiments, as shown in FIG. 6 or FIG. 8, the first connector 430 includes a crossbeam 431, two transition portions 432, and two connecting portions 433. The length direction of the crossbeam 431 is the third direction Z. The two transition portions 432 are connected to two ends of the crossbeam 431 in the length direction, respectively. The two connecting portions 433 are connected to the two transition portions 432 in a one-to-one correspondence. Each connecting portion 433 is connected to one end of the transition portion 432 away from the crossbeam 431 to form the first connector 430 in the shape of Ω. The two connecting portions 433 are connected to two first free ends 412 in the corresponding piezoelectric group, respectively. In this manner, the first connector 430 can be better supported between the first diaphragm assembly 200 and the two first piezoelectric structures 410, the first connector 430 can have a higher structural domain strength, and the probability of deformation of the first connector 430 is reduced. It should be noted that the large surface of the crossbeam 431 (that is, the surface with a larger area of the crossbeam 431) is connected to the first diaphragm assembly 200 to increase the connection area between the two and ensure connection strength. Similarly, the large surface of the connector 433 (that is, the surface with a larger area of the connector 433) is connected to the first piezoelectric structure 410 to increase the connection strength between the connector 433 and the first piezoelectric structure 410 and reduce the probability of connection failure.

Further in one or more embodiments, as shown in FIG. 8, the angle between the transition portion 432 and the crossbeam 431 is a, and the angle between the transition portion 432 and the connecting portion 433 is b, where a and b are both greater than 90 degrees. Thus, on the one hand, the first connector 430 has a certain elasticity in the first direction X and can buffer the force transmitted from the first piezoelectric structure 410 to the first diaphragm assembly 200, thereby reducing the probability of damage to the first diaphragm assembly 200; on the other hand, the spacing between the two transition portions 432 and one end of the corresponding connecting portion 433 is large and can meet the requirement that the transition portion 432 does not interfere with the second piezoelectric structure 420.

As shown in FIG. 2, the second connector 440 in this embodiment may be a block-shaped structure, which is not limited in this embodiment.

To make the areas of the first piezoelectric structure 410 and the second piezoelectric structure 420 larger, in this embodiment, as shown in FIG. 5, the width of the first piezoelectric structure 410 gradually decreases in a direction from the first fixed end 411 to the first free end 412; and the width of the second piezoelectric structure 420 gradually decreases in a direction from the second fixed end 421 to the second free end 422. In some optional embodiments, the first piezoelectric structure 410 and the second piezoelectric structure 420 have the same shape, and the number of first piezoelectric structures 410 is the same as the number of second piezoelectric structures 420, so as to ensure the consistency of the driving effect on both the first diaphragm assembly 200 and the second diaphragm assembly 300. Preferably, the number of first piezoelectric structures 410 and the number of second piezoelectric structures 420 are both even numbers.

For example, the shape of the first piezoelectric structure 410 and the shape of the second piezoelectric structure 420 may both be trapezoidal. Of course, it can be understood that the shape of the first piezoelectric structure 410 and the shape of the second piezoelectric structure 420 may also be rectangular, triangular, and the like, which is not limited in this embodiment.

In the piezoelectric speaker provided in this embodiment, the first piezoelectric structure 410 and the second piezoelectric structure 420 are located on the same layer; the first piezoelectric structure 410 is connected to the first diaphragm assembly 200, and the second piezoelectric structure 420 is connected to the second diaphragm assembly 300, thus driving the first diaphragm assembly 200 and the second diaphragm assembly 300 to vibrate in opposite directions. This configuration allows the piezoelectric speaker, based on a dual-diaphragm structure, to achieve its thinnest form, reducing the space occupied by the piezoelectric speaker in the first direction X, while also playing a role in shock absorption.

It is to be noted that the preceding are only preferred embodiments of the present disclosure and technical principles used therein. It is to be understood by those skilled in the art that the present disclosure is not limited to the embodiments described herein. Those skilled in the art can make various apparent modifications, adaptations, and substitutions without departing from the scope of the present disclosure. Therefore, although the present disclosure is described in detail through the preceding embodiments, the present disclosure is not limited to the preceding embodiments and may include more other equivalent embodiments without departing from the concept of the present disclosure. The scope of the present disclosure is determined by the scope of the appended claims.

What is claimed is:

1. A piezoelectric speaker, comprising:
a support frame, wherein the support frame forms a cavity penetrating an upper surface and a lower surface;
a circuit assembly disposed in the support frame;
a first diaphragm assembly, wherein a periphery of the first diaphragm assembly is fixedly connected to the support frame;
a second diaphragm assembly, wherein the second diaphragm assembly is disposed opposite to the first diaphragm assembly in a first direction, and a periphery of the second diaphragm assembly is fixedly connected to the support frame; and
a vibration assembly, wherein the vibration assembly is disposed in the cavity and located between the first diaphragm assembly and the second diaphragm assembly, and the vibration assembly comprises a first piezoelectric structure and a second piezoelectric structure that are disposed on a same layer on the support frame; wherein the first piezoelectric structure and the second piezoelectric structure are electrically connected to the circuit assembly, the first piezoelectric structure is fixedly connected to the first diaphragm assembly and is configured to drive the first diaphragm assembly to vibrate in the first direction, and the second piezoelectric structure is fixedly connected to the second diaphragm assembly and is configured to drive the second diaphragm assembly to vibrate in the first direction.

2. The piezoelectric speaker of claim 1, wherein at least one of the following is satisfied:
the vibration assembly further comprises a first connector connected between the first piezoelectric structure and the first diaphragm assembly; or,
the vibration assembly further comprises a second connector connected between the second piezoelectric structure and the second diaphragm assembly.

3. The piezoelectric speaker of claim 1, wherein a plurality of first piezoelectric structures are provided, and the vibration assembly further comprises a first connector connected to the first diaphragm assembly; one first connector is provided, and all first piezoelectric structures of the plurality of first piezoelectric structures are connected to the one first connector to be connected to the first diaphragm assembly through the one first connector; or a plurality of first connectors are provided, and each first connector of the plurality of first connectors is connected to at least one first piezoelectric structure of the plurality of first piezoelectric structures.

4. The piezoelectric speaker of claim 3, wherein a plurality of second piezoelectric structures are provided, and the vibration assembly further comprises a second connector connected to the second diaphragm assembly; one second connector is provided, and all second piezoelectric structures of the plurality of second piezoelectric structures are connected to the one second connector to be connected to the second diaphragm assembly through the one second connector; or a plurality of second connectors are provided, and each second connector of the plurality of second connectors is connected to at least one second piezoelectric structure of the plurality of second piezoelectric structures.

5. The piezoelectric speaker of claim 1, wherein the first piezoelectric structure has a first free end and a first fixed end that are opposite to each other in a second direction, the first fixed end is connected to one end of the support frame, and the first free end is fixedly connected to the first diaphragm assembly; the second piezoelectric structure has a second free end and a second fixed end that are opposite to each other in the second direction, the second fixed end is connected to another end of the support frame, and the second free end is fixedly connected to the second diaphragm assembly; wherein the first direction is perpendicular to the second direction.

6. The piezoelectric speaker of claim 5, wherein an orthographic projection of the first piezoelectric structure at least partially overlaps an orthographic projection of the second piezoelectric structure in a third direction; wherein the third direction is perpendicular to the first direction and the second direction.

7. The piezoelectric speaker of claim 6, wherein an area of a part where an orthographic projection of the first piezoelectric structure overlaps an orthographic projection of the second piezoelectric structure in the third direction is smaller than the area of the orthographic projection of the first piezoelectric structure in the third direction and is smaller than the area of the orthographic projection of the second piezoelectric structure in the third direction.

8. The piezoelectric speaker of claim 6, wherein first free ends of first piezoelectric structures and second free ends of second piezoelectric structures are alternately arranged in the third direction.

9. The piezoelectric speaker of claim 6, wherein a plurality of first piezoelectric structures are arranged in the third direction, at least one second piezoelectric structure is provided, two adjacent first piezoelectric structures of the plurality of first piezoelectric structures in the third direction and one or more second piezoelectric structures of the at least one second piezoelectric structure form a piezoelectric group, and in one piezoelectric group, a second free end of the one or more second piezoelectric structures is located between two first piezoelectric structures of the plurality of first piezoelectric structures in the third direction.

10. The piezoelectric speaker of claim 7, wherein the vibration assembly further comprises a first connector and each first connector is connected to at least one first piezoelectric structure.

11. The piezoelectric speaker of claim 7, wherein the vibration assembly further comprises a plurality of first connectors, the plurality of first connectors and the plurality of first piezoelectric structures are in a one-to-one correspondence and each first piezoelectric structure of the plurality of first piezoelectric structures is connected to a corresponding first connector of the plurality of first connectors.

12. The piezoelectric speaker of claim 9, wherein the vibration assembly further comprises a first connector; in the one piezoelectric group, the two first piezoelectric structures are connected to a same first connector, the first connector is disposed across the one or more second piezoelectric structures, and a portion of the first connector opposite to the one or more second piezoelectric structures protrudes in a direction away from the one more second piezoelectric structures and is connected to the first diaphragm assembly.

13. The piezoelectric speaker of claim 12, wherein the first connector comprises a crossbeam, two transition portions, and two connecting portions, the two transition portions are connected to two ends of the crossbeam, respectively, the two connecting portions are connected to the two transition portions in a one-to-one correspondence, the two connecting portions are connected to two first free ends, respectively, a transition portion of the two transition portions forms an angle greater than 90 degrees with the crossbeam and forms an angle greater than 90 degrees with a connecting portion of the two connecting portions, and the crossbeam is connected to the first diaphragm assembly.

14. The piezoelectric speaker of claim 6, wherein a plurality of first piezoelectric structures and a plurality of second piezoelectric structures are provided, wherein a plurality of second piezoelectric structures are disposed between two first piezoelectric structures spaced apart in the third direction; and
the vibration assembly further comprises a second connector, the plurality of second piezoelectric structures disposed between the two first piezoelectric structures are connected to a same second connector, and the second connector is connected to the second diaphragm assembly.

15. The piezoelectric speaker of claim 5, wherein at least one of the following is satisfied:
a width of the first piezoelectric structure gradually decreases in a direction from the first fixed end to the first free end; or,
a width of the second piezoelectric structure gradually decreases in a direction from the second fixed end to the second free end.

16. The piezoelectric speaker of claim 1, wherein the first piezoelectric structure comprises a first substrate and a first piezoelectric sheet disposed on at least one side of the first substrate, and the first substrate and the first piezoelectric sheet are disposed in the first direction.

17. The piezoelectric speaker of claim 1, wherein the second piezoelectric structure comprises a second substrate and a second piezoelectric sheet disposed on at least one side of the second substrate, and the second substrate and the second piezoelectric sheet are disposed in the first direction.

18. The piezoelectric speaker of claim 1, wherein at same time, a vibration direction of the first diaphragm assembly is opposite to a vibration direction of the second diaphragm assembly.

19. The piezoelectric speaker of claim 2, wherein at same time, a vibration direction of the first diaphragm assembly is opposite to a vibration direction of the second diaphragm assembly.

20. The piezoelectric speaker of claim 3, wherein at same time, a vibration direction of the first diaphragm assembly is opposite to a vibration direction of the second diaphragm assembly.
